(19) United States
(12) Patent Application Publication
(10) Pub. No.: US 2017/0132706 A1
(43) Pub. Date: May 11, 2017

(54) Preference Based Financial Tool System and Method

(71) Applicant: Capital Preferences, Ltd., Staten Island, NY (US)

(72) Inventors: Shachar Kariv, Piedmont, CA (US); Jay Womack, Cherry Hill, NJ (US); Bernard Del Rey, Christchurch (NZ); Daniel S. Silverman, Paradise Valley, AZ (US)

(73) Assignee: Capital Preferences, Ltd., Staten Island, NY (US)

(21) Appl. No.: 15/153,365

(22) Filed: May 12, 2016

Related U.S. Application Data
(60) Provisional application No. 62/160,841, filed on May 13, 2015.

(51) Int. Cl. G06Q 40/06; G06Q 40/02; G06Q 40/08

(52) U.S. Cl. CPC G06Q 40/06; G06Q 40/08; G06Q 40/025

(57) ABSTRACT

Disclosed is a preference-based financial tool system and method. In one embodiment, the present system includes a user interface for obtaining responses to a series of textual or graphical questions via a game or an activity, from a user, that can be algorithmically combined with defined utility curves to identify multi-dimensional measures of individual financial preferences. For instance, some embodiments of the present invention measure risk aversion, loss aversion, ambiguity aversion, time preferences, and distributional preferences. These preferences define a user's economic fingerprint that can be used to determine and understand the user's financial risk preferences, recommend products, educate individuals on decision-making, and make trade-off decisions.

### CROSS REFERENCE TO RELATED APPLICATIONS

This application claims the benefit of, and priority from, U.S. Provisional Patent Application No. 62/160,841, filed May 13, 2015, the entire disclosures of which are incorporated herein by reference.

### FIELD OF THE INVENTION

The present invention relates generally to preference-based financial tool; and, more particularly, to the use of a computer interface to obtain responses to a series of textual or graphical questions that can be algorithmically combined with defined utility curves to identify multi-dimensional measures of individual financial preferences.

### BACKGROUND OF THE INVENTION

Various types of financial instruments for individual investment planning to achieve an individual's short-term and long-term financial goals exist in the art. Many of these systems and methods generally attempt to design an appropriate investment policy for the individual's portfolio or to make asset allocation suggestions based on information obtained from the individual.

Existing systems and methods generally obtain information and data from individuals by asking brief and direct questions that primarily focus on limited factors such as time horizon and risk tolerance. These systems and methods, however, are disadvantageous in that they do not integrate a truly revealed preferences approach with statistical certainty and that they do not measure any changes in individual preferences over time.

Specifically, these systems and methods do not recover individual preferences along a common set of criteria and then execute a portfolio optimization using those defined preferences. In this way, existing investment systems and methods do not gather data from individuals in a meaningful manner, do not account for true individual preferences, and do not quantify any uncertainty about individual preferences. Therefore, there is a need in the prior art for an improved system and method of providing a personalized financial planning (e.g., investment portfolio and asset allocation plan). In this regard, the invention described herein addresses this problem.

### SUMMARY OF THE INVENTION

In view of the disadvantages inherent in the known types of financial instruments and methods now present in the prior art, the present invention provides an improved financial tool system and method that integrate a truly revealed preferences approach.

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

One embodiment of the present invention includes systems and methods for portfolio optimization that is based upon algorithmically recovered preferences such as risk aversion, loss aversion, ambiguity (uncertainty) aversion, present bias and time discounting (time preferences), and legacy (distributional preferences). The foregoing preferences (i.e., risk aversion, loss aversion, ambiguity aversion, present bias and time discounting, and legacy) are neither inclusive nor exclusive in that any one or more of the preferences may be used in developing personalized utility curves, depending upon embodiment.

These preferences can be measured using individually tailored tests in a game interface (accessible via, e.g., a game module in an application) that generate many observations per subject over a wide range of choice sets. Thus, the present invention provides each subject with many choices in the course of one or more sessions to yield a large data set, thereby allowing for statistically meaningful analysis of consistency and attitude of individuals. Additionally, individuals can be periodically tested over a period of time to determine any changes in preference measures.

A utility curve is developed for each test implementation: 1) decisions under risk, which measure risk and loss aversion; 2) decisions under ambiguity, which measure risk and ambiguity aversion; 3) time preferences, which measure implied internal rate of return (IRR) and present bias, if any; and 4) distributional preferences or legacy preferences. An individual's portfolio optimization process is approximated by a point estimate and confidence interval of utility for a given allocation by using a Taylor Series expansion. In some embodiments, two or more individual utility functions can be combined using a weighting scheme to create utility functions for groups of two or more individuals (e.g., husband and wife, heirs in a trust, etc.).

Some embodiments include a system comprising a memory unit having preference based financial management and planning instructions, and a processor to execute the instructions via an application (e.g., a web application, a website, a stand-alone application, a mobile application, etc.). This allows the system to identify an individual's “point-in-time” economic fingerprint, which defines the individual's preference measures and comprises comprehensive individual profiles. In this way, the system uses the economic fingerprint to determine and understand an individual's financial risk preferences, recommend products, educate individuals on decision-making, and make trade-off decisions. Additionally, the preference measures are used to associate an individual's portfolio with financial advising, risk profiling, product mapping, and credit scoring satisfying at least one predefined criterion.

Some embodiments of the present invention further account for changes in an individual's preferences over time. More specifically, the application is configured to optimize investment portfolios by maximizing the utility calculated using a customized utility function that is defined by the foregoing preference measures, subject to constraints. The game module can also modify tests such that an axis on the test can be scaled to reflect a specific variable such as an individual's net worth and adjusted in context to fit a particular situation. For example, tests can be specifically created for retirement planning.

In this regard, the present invention significantly differs from traditional approach to portfolio optimization in that it offers a flexible, interactive approach to investment portfolio optimization that can accommodate the various utility functions and deliver a portfolio that maximizes profit subject to target expected return and constraints.

In the light of the foregoing, these and other objects are accomplished in accordance of the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 depicts an exemplary block diagram of the present system.

FIGS. 2A through 2D show exemplary embodiments of the game interface of the present invention.

FIG. 3 depicts an exemplary flow chart of the scoring process of the present method.

FIG. 4A depicts the portfolio construction process of the present method.

FIG. 4B depicts an exemplary portfolio optimization process.

FIG. 4C depicts an exemplary portfolio mapping process.

FIG. 5A depicts the financial product rating process of the present method.

FIG. 5B depicts an exemplary product scoring process.

FIG. 6 depicts the financial product eligibility process of the present method.

FIG. 7 depicts the product recommendation process of the present method.

### DETAILED DESCRIPTION OF THE INVENTION

The present invention is directed towards a system for a financial tool and method of use thereof. For purposes of clarity, and not by way of limitation, illustrative views of the present system and method are described with references made to the above-identified figures. Various modifications obvious to one skilled in the art are deemed to be within the spirit and scope of the present invention.

As used in this application, the terms “component,” “module,” “system,” “interface,” or the like are generally intended to refer to a computer-related entity, either hardware or a combination of hardware and software. For example, a component can be, but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Some portions of the present invention are presented in terms of algorithms and other representations of operations on data bits or binary digital signals within a computer memory. It is to be appreciated that determinations or inferences referenced throughout the subject specification can be practiced through the use of artificial intelligence techniques. More specifically, the terms “processing,” “computing,” “calculating,” “determining,” “establishing,” “analyzing,” “identifying,” “checking,” or the like, may refer to operations and/or processes of a computer, a computing platform, a computer system, or other electronic device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” or “at least one” unless specified otherwise or clear from context to be directed to a singular form. The terms “end user” or “user” as used herein may refer to any “customer,” “individual,” “client,” “test taker,” “player,” or another operator of a user device unless the context clearly suggests otherwise. Finally, the terms “activity,” “game,” and “test,” are used interchangeably unless the context clearly suggests otherwise.

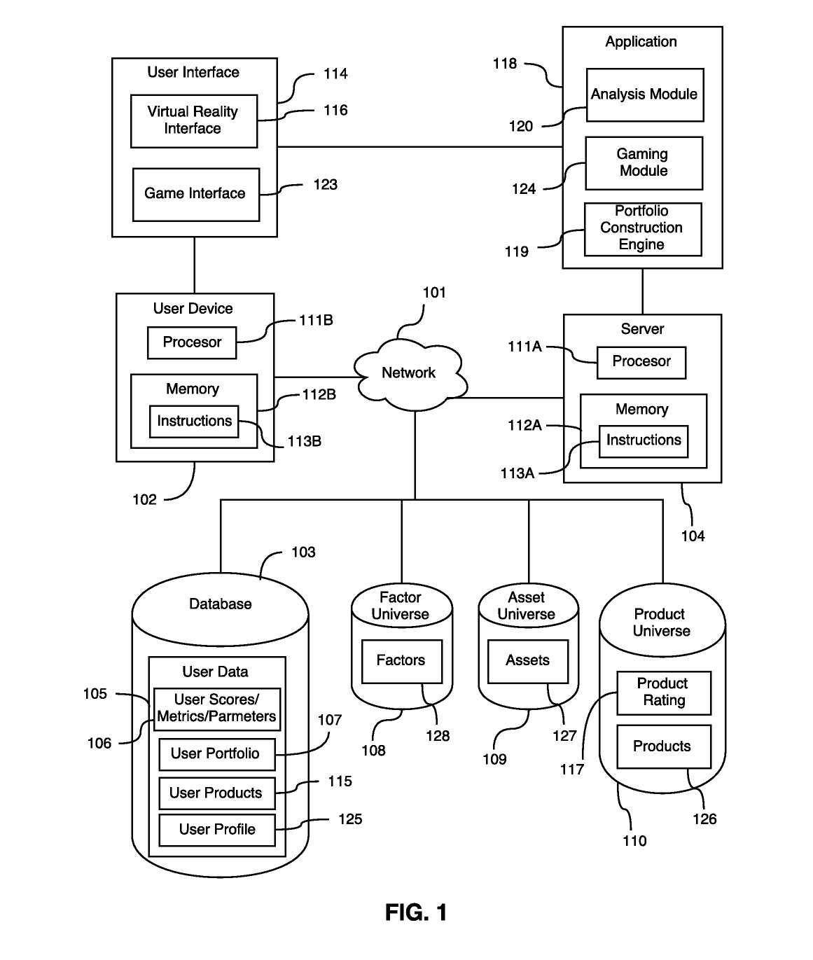

Referring now to FIG. 1, there is shown an exemplary block diagram of the present system. The present system comprises at least one user device 102 that is operated by an end user, wherein the user device 102 comprises various types of computer systems, such as a desktop computer, a laptop, a smart phone, a personal digital assistant (PDA), a computer tablet, or the like. In this regard, the user device comprises a processor 111B, a memory unit 112B for storing instructions 113B, and other components for operating the same, such as controllers, input/output units (e.g., keyboard, mouse, touch screen, microphone, speakers, display screen, monitor), communication units, operating systems, and the like.

The user device 102 is connected to a network 101 (e.g., the Internet, LAN), and is configured to access a user interface 114 that is available via an application 118, wherein the application 118 comprises a website, a web application, a mobile application, and other types of downloadable and/or non-downloadable program. It is contemplated that the system may further comprise an application server 104 for supporting the application 118, wherein the server 104 also comprises a computer system comprising a processor 111A and a memory unit 112A having instructions 113A stored thereon.

The user interface 114 facilitates communication between the user device 102 (and hence the end user) and one or more elements of the present system (e.g., the application 118). In this regard, the user interface 114 may be configured to allow users to enter commands, to input and receive information, to define financial parameters, to receive financial analysis, and/or to view reports. Without limitation, the application 118 may include a gaming module 124, a portfolio construction engine 119, an analysis module 120, and other suitable financial management and planning service tools.

The user interface 114 comprises a graphic user interface for interacting with an end user via the user device 102. In one embodiment, the graphic user interface comprises a virtual reality interface 116 that allows the end user to play games and complete interactive tasks or activities in a virtual world. For instance, the user may be invited to take a sum of investable assets and place them on a virtual game board to make decisions on allocating the asset in the context of risk, time, or distributional preferences related to the assets. The user would be able to see analysis or view the outcomes of their decisions that aid in future decision making, financial planning, and product recommendations. The virtual world can be tailored to each user so that the games and activities are more context-specific (e.g., planning for retirement, purchasing a home, repaying student loans, other financial related goals). Alternatively, the virtual world can imitate real-life experience provided by commercial service providers.

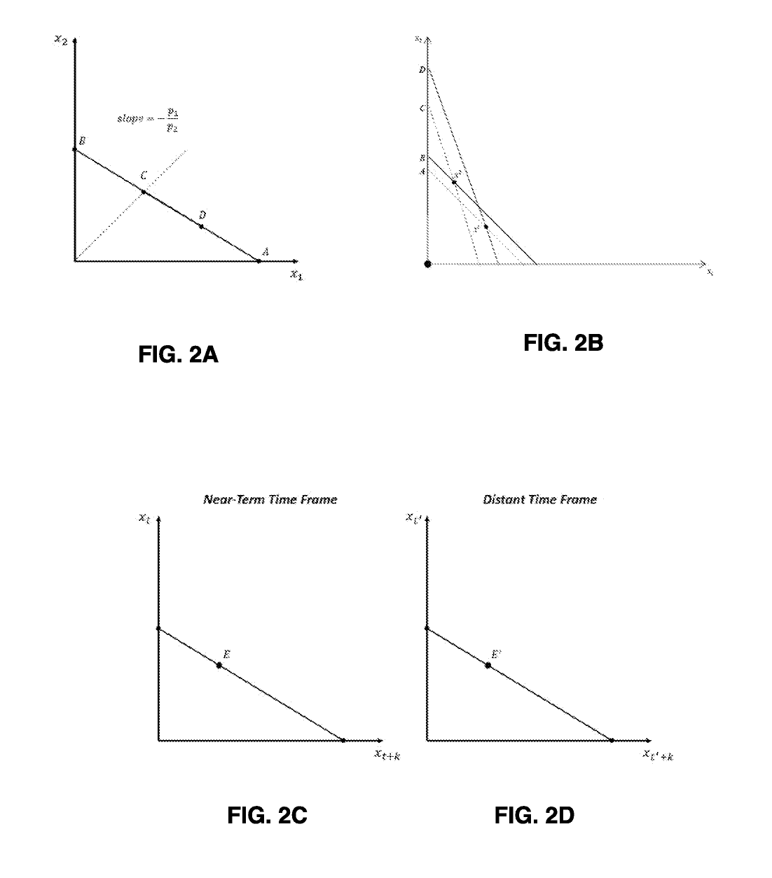

In another embodiment, the user interface 114 allows the end user to play games or complete activities via 2D and/or 3D game interface 123. Without limitation, the 2D and/or 3D game interface 123 can comprise graphs or charts that can be manipulated by the user, as depicted in FIG. 2A. A gaming module 124 of the application 118 controls the game interface 123, as well as the games and activities provided in the virtual reality interface 116. The gaming module 124 allows the end user to make one or more tradeoff decisions between two or more arbitrary items or outcomes related to risk, uncertainty, time, transition decision making and preferences in the domain of risk preferences, and/or distribution via the game interface 123 or the virtual reality interface 116.

The gaming module 124 can individually tailor games or activities based on various factors such as socio-economic factors of the end user and the end user's financial goals, among types of factors 128, for example, from a factor universe 108. The results of the user's decisions or performances, or the metrics derived from the games or activities are used to calculate preference parameters and scores or data points, with statistical confidence intervals 106. The data points or scores represent the end user's “point-in-time” economic fingerprint.

The metrics, preference parameters, game scores, or data points 106 for each end user are associated with respective user data 105 and stored in a database 103 so that it can be retrieved later for various applications, such as financial planning, portfolio construction, financial product rating, financial product eligibility, and product recommendations. The database 103 further comprises other types of user data 103 associated with one or more users. For instance, the user data 103 comprises user profile 125 that includes demographic information (e.g., age, sex, marital status, occupation, etc.), financial goals, assets, and account information corresponding to one or more users. Other non-limiting examples of the user data 103 comprise information pertaining to portfolios 107 and financial products 115 belonging to individual users. In this regard, portfolio information 107 comprises details about assets and amounts of assets associated with one or more users. Similarly, financial products information 115 comprises details about past and current financial instruments purchased by, used by, or associated with one or more users.

In some embodiments, the application 118 utilizes users' inputs from the games or activities to automatically calculate preference parameters, with confidence intervals, for individual users based on internally defined utility functions corresponding to one or more user-specific applications (i.e., portfolio construction, financial product rating, financial product eligibility, and product recommendations).

In some embodiments, the application 118 may be capable of analyzing the metrics to, for example, identify individual risk preferences, individual time preferences, and individual distributional preferences. Additionally, the application 118 may be capable of automatically confirming that the data points are consistent with any preference ordering. The application 118 can also utilize the metrics to identify any user-specific pattern (e.g., behavioral pattern, income flow, repeat expenses) and generate predictive data corresponding to the user.

In some embodiments, the application 118 may be capable of automatically generating a financial plan that consists of an investment portfolio, asset allocation plan, and product recommendations based on point-in-time needs as determined by a stochastic simulation of the future path for an individual. More specifically, the application 119 takes into account user constraints (e.g., income, investable assets, expected future income, current and expected future expenses, etc.), user goals, and user-specific preferences to provide financial planning and recommendations for products that may be required at different points in time. Without limitation, the overall financial plan can comprise an expense/savings plan, an investment portfolio with recommended adjustments over time, insurance, annuities, and other financial products that all work together to achieve the objective of meeting a user's goals or to meet a targeted milestone while considering risk, ambiguity, time, legacy, and distributional preferences.

In some embodiments, the application 118 may be capable of automatically calculating, e.g., via a portfolio construction engine 119, best-fit portfolio or optimizing portfolio to maximize the utility function. In this regard, the application 118 takes into account individual risk preferences, individual time preferences, and/or individual distributional preferences to optimize a portfolio. It also accounts for statistical uncertainty regarding these preferences.

In some embodiments, the application 118 may be capable of automatically recommending financial instruments, products, and/or services by using a user's metrics, scores or data points derived from the preference parameters, financial constraints, and/or predictive data corresponding to the user. Additionally, the application 118 may be capable of measuring fit for financial instruments, products, and/or services. In this regard, the application 118 communicates with the product universe 110 to access information and recommend products, instruments, and/or services therefrom.

In some embodiments, the application 118 may be capable of rating financial instruments, products, and/or services (e.g., credit cards, insurance, credit and loans, etc.) using a user's scores, data points, metrics, and/or other constraints. In this regard, the application 118 may be adapted to interact with the product universe 110 to rate the products 126 therein and store product-rating 117 for corresponding products 126.

In some embodiments, the application 118 may be capable of preference-based goal ranking. In this regard, the application 118 can use parameters to calculate for each financial goal, the allocation that yields the highest expected utility given a starting level of wealth and/or some level of ongoing contribution to a portfolio with a rate of return.

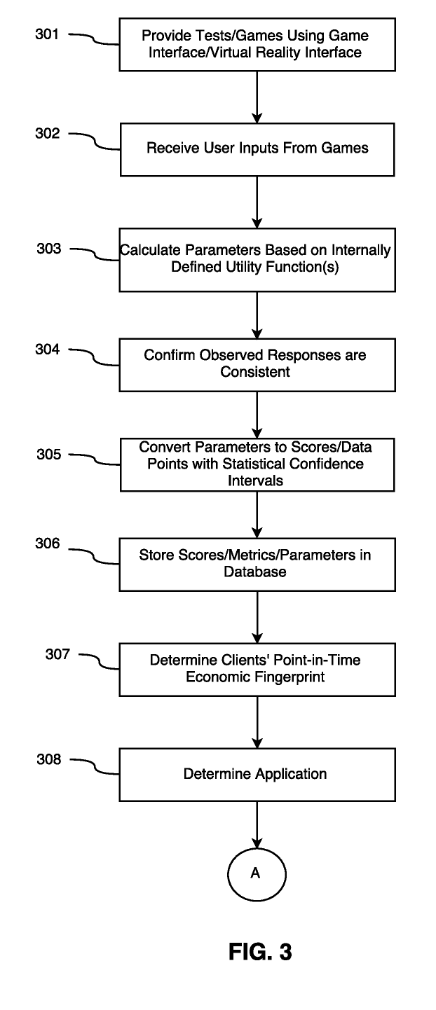

Reference is also made to FIGS. 3 through 7, which schematically illustrates exemplary methods of the present invention. One or more of the operations of FIGS. 3 through 7 may be performed by one or more elements of the present system as illustrated in FIG. 1. As indicated in block 301, the method includes administering tests or providing games or activities for measuring a person's financial preferences to one or more users using the game interface 123 (FIG. 1) and/or virtual reality interface 116 (FIG. 1).

As indicated in block 302, the method includes receiving user inputs or metrics corresponding to one or more users from the administered games or activities. For example, the gaming module 124 (FIG. 1) may keep track of a user's activities or decisions and allow the user to record or save his or her decisions manually or automatically record the same in corresponding user's data 105 (FIG. 1). As indicated in block 303, the method includes calculating preference parameters based on internally defined utility functions via, e.g., the application 118 (FIG. 1) using the user inputs from the games or activities provided by the gaming module 124.

### Individual Risk Preferences

In one embodiment, the games or the activities measure individual risk preferences. In this regard, “risk preferences” measure an end user's attitude towards risk. Each assessment comprises a series of decisions. Preferably, each assessment for the user's attitude toward risk may comprise eight or more independent decision rounds. In this way, the application 118 (FIG. 1) can gather a large enough sample size to objectively measure variation and increase quality of the data obtained by confirming that the user's responses are consistent with any preference ordering. In each round, the user is asked to allocate an amount between two arbitrary assets, labeled x₁ and x₂. The x₁ account corresponds to the x-axis and the x₂ account corresponds to the y-axis in a two-dimensional graph, as depicted, for example, in FIG. 2A.

Each choice involves choosing a point on a budget line of possible combination of payments, wherein the line represents a budget constraint. The point C, which lies on the 45-degree line, corresponds to a portfolio with a certain payoff. By contrast, point A and point B represent a portfolio in which all wealth is invested in the security that pays off in state 1 and state 2, respectively. A portfolio at point C is called a “safe portfolio” and portfolios at points A and B are called “boundary portfolios.” A portfolio at D is neither a safe nor a boundary portfolio, and is called an “intermediate portfolio.”

Each round of the games or activities starts by having the gaming module 124 (FIG. 1) select a budget line randomly. The payoffs at various points along the line depend on the payoffs in states 1 and 2. The budget lines selected for each decision problem or round are independent of each other and of the budget lines selected for other individuals. The axes are scaled to represent a meaningful economic choice given the domain in which preferences are being measured (e.g., retirement planning, significant purchases, etc.). When completing individual decision problems within the game or activity, to choose a combination, for example, the user can utilize the user device 102 (FIG. 1) to drag or move a point on the graph to the desired location.

The games or the activities are preferably configured to measure three risk attitudes by measuring levels of preference (i.e., aversion/tolerance) to uncertainty under the following two conditions: 1) uncertain outcomes with known probabilities; and 2) uncertain outcomes with unknown probabilities. In the first instance, users make decisions under conditions where outcomes are uncertain, but the probabilities of those outcomes are known. A single line of the graph describes a menu of payoffs determined by two uncertain outcomes with known probabilities. Choices from that line represent the most basic form of risk taking. The combination of decisions across multiple lines enables the identification of risk and loss aversion. Therefore, from these decisions, users' preferences for risk (risk aversion) and loss (loss aversion) are measured.

In the second scenario, users make decisions under conditions where both the outcomes and the probability of those outcomes are uncertain (ambiguity). A single line of the graph with two known outcomes but unknown probabilities is a variant of basic risk taking. However, in this instance, the combination of decisions across multiple lines enables the identification of ambiguity aversion. As a result, from these decisions, users' preferences towards ambiguity (ambiguity aversion) are measured. These three aversions: risk aversion; loss aversion; and ambiguity aversion, represent a rich description of a user's risk preferences. Risk aversion measures individual attitudes towards risk-taking; loss aversion measures the additional aversion a user experiences when dealing with losses versus gains; ambiguity aversion is the additional aversion a user experiences when dealing with ambiguous situations versus ones where the risks are better known.

In this regard, the application 118 (FIG. 1) utilizes the loss/disappointment aversion over portfolios (x₁, x₂) and embeds the standard Expected Utility Theory (EUT) representation as a parsimonious and tractable special case and allows for the estimation of the parameter values for risk and loss aversion based on the decisions. In some embodiments, the application 118 (FIG. 1) may utilize the Hyperbolic Absolute Risk Aversion (HARA) class of utility functions (including negative exponential (CARA) and power (CRRA) utility functions) that, given special cases, include the quadratic utility function, exponential utility function, and power utility function.

The application 118 (FIG. 1) utilizes the calculated parameters of risk aversion and loss aversion to measure expected utility (to determine preference-based asset allocation for risk vs. loss and ambiguity), accounting for the separate treatment of gains and losses, and accounting for the statistical precision of the aversion calculations.

### Individual Time Preferences

In one embodiment, the games or the activities measure individual time preferences. In this regard, “time preferences” measure an individual's preferences for the allocation of consumption or wealth over time. Each assessment comprises a series of decisions. Preferably, each assessment for the user's attitude toward time may comprise an even number of ten or more independent decision rounds (n rounds). In each of the first n/2 rounds, an individual is asked to allocate an endowment that will be received between two arbitrary points in time, t and t+k, wherein t represents an earlier time than t+k, which is k units of time after t. The xₜ amount corresponds to the y-axis and the Xₜ₊ₖ amount corresponds to the x-axis in a two-dimensional graph or vice versa, as depicted in FIGS. 2C and 2D.

Each choice involves choosing a point on a budget line of possible combinations of payments. Each round starts by having the gaming module 124 (FIG. 1) select a budget line randomly. In remaining n/2 rounds, the gaming module 124 (FIG. 1) asks a user to choose an endowment that will be received between two arbitrary points in time, t′ and t′ +k, where t′ is some number>k periods after t. The x_{t′} amount corresponds to the y-axis and the X_{t′+k} amount corresponds to the x-axis in a two-dimensional graph.

Each choice involves choosing a point on a budget line of possible combinations of payments. In the latter rounds, the gaming module 124 (FIG. 1) randomly selects budget lines from the first n/2 rounds, without repetition. The axes are scaled to represent a meaningful economic choice given the domain in which preferences are being measured. When completing individual decision problems, to choose a combination, for example, the user can utilize the user device 102 (FIG. 1) to drag or move a point on the graph to the desired location.

Two forms of time preference are measured: 1) the degree to which a person exhibits present bias, or a strong preference for near-term payoffs (i.e., instant gratification); and 2) the implied rate at which an individual discounts money over time beyond the present (i.e., general time discounting). In the first instance, the users make decisions about how they would like to allocate an endowment, with certainty, between two points in time in the “near term,” as depicted in FIG. 2C. In the second instance, the user is asked to make decisions about how they would allocate an endowment over time in the “long term,” as depicted in FIG. 2D.

The application 118 (FIG. 1) utilizes utility functions over the allocation (xₜ, xₜ₊ₖ) to calculate the parameter values for a user's time preferences. The calculated parameters are used to measure utility, potentially accounting also for risk attitudes and the separate treatment of gains and losses. In this regard, the effects of individual time discounting are considered by optimizing consumption over some period of time, inclusive of any lump sum outflows.

### Individual Distributional Preferences

In one embodiment, the games or the activities measure individual distributional preferences. In this regard, “distributional preferences” measure the degree to which a person prefers to allocate money to themselves and others. Preferences for giving measure a user's preference for allocations to self versus an “other,” while social preferences, or legacy preferences, measure the relative preferences given an allocation of money between two or more “others.” In both instances, the “other” can be a person, an entity, an organization, or a good that might be considered in long-term financial planning or estate planning.

In other embodiments, distributional preferences measure the degree to which a person prefers to allocate money between two or more goals. Relative preferences for goals measures a user's preference for allocations to one goal versus another goal. More generally, distributional preferences measure the relative preferences regarding the allocation of money among multiple goals.

Each assessment comprises a series of decisions. Preferably, each assessment consists of eight or more independent decision rounds. In each round, the gaming module 124 (FIG. 1) asks a user to allocate an endowment that will be divided between those represented in the tradeoff scenario: self versus other; other versus other; goal versus goal; self versus other versus other; or goal versus goal versus goal. In the first three scenarios, preferences are measured in a two-dimensional space (as depicted in FIG. 2A), whereas preferences between self and two others or a goal and two other goals are measured concurrently using a three-dimensional space.

Each choice involves choosing a point on a budget line (or a budget surface in a self versus two others scenario) of possible combinations of payments. Each round starts by having the gaming module 124 (FIG. 1) select a budget line randomly. The axes are scaled to represent a meaningful economic choice given the domain in which preferences are being measured. When completing individual decision problems, to choose a combination, for example, the user can utilize the user device 102 (FIG. 1) to drag or move a point on the graph to the desired location. Distributional preferences are estimated using constant elasticity of substitution (CES) demand function.

As indicated in block 304, calculated risk aversion and loss aversion for each user can be verified for consistency by verifying that it satisfies Generalized Axiom of Revealed Preference (GARP). Additionally, GARP violations can be measured using an index, for example, Afriat's Critical Cost Efficiency Index (CCEI). CCEI is a number between value of 0 and 1, wherein a value of 1 indicates that the data satisfy GARP perfectly. There is no natural threshold for determining whether subjects are close enough to satisfying GARP that they can be considered utility maximizers. FIG. 2B shows how one budget constraint must be adjusted in order to remove all violations of GARP for two portfolios or for two endowment combinations x₁ and x₂, depending upon embodiment. Particularly, FIG. 2B shows that GARP violations are removed when the budget constraints are shifted through x₂. The CCEI is proportional to the magnitude of this adjustment and quantifies the degree of consistency (i.e., confidence intervals). The foregoing analyses can quantify the consistency of individual choices and make more precise measures of a user's attitudes toward risk and time. These measures of consistency and attitudes can also be related to observable characteristics and behaviors, thereby improving the overall financial advising process.

As indicated in block 305, the method includes mapping risk, loss, and ambiguity preference parameters, estimated via the application 118 (FIG. 1), into scores or data points with statistical confidence intervals for various use (e.g., providing financial advice). In one embodiment, the scores range from value of 0 to 100. There are up to three suggested scores for each functional form of utility, of which CARA and CRRA are outlined for a score for risk aversion, a score for loss aversion, and a score for ambiguity aversion.

The application 118 determines which scores to use depending on the functional form of utility (i.e., CARA, CRRA) that is used in the estimation of preference parameters in light of the preferred parameterization. For scoring risk and loss parameters and risk, loss, and ambiguity parameters, the scores describe the percentage of an individual's portfolio the individual would be willing to trade for a double-or-nothing bet of that portfolio. In scoring time preferences, given the two treatments for time assessments, the score is framed in the context of the user's willingness to wait, a personal interest or discount rate.

As indicated in block 306, the calculated scores, metrics, and parameters 106 (FIG. 1) are stored in the database 103 (FIG. 1). A user's scores and metrics define the user's point-in-time economic fingerprint. Thus, the user's scores and metrics can be used to determine and understand an individual's financial risk preferences, recommend products, educate individuals on decision-making, and make trade-off decisions.

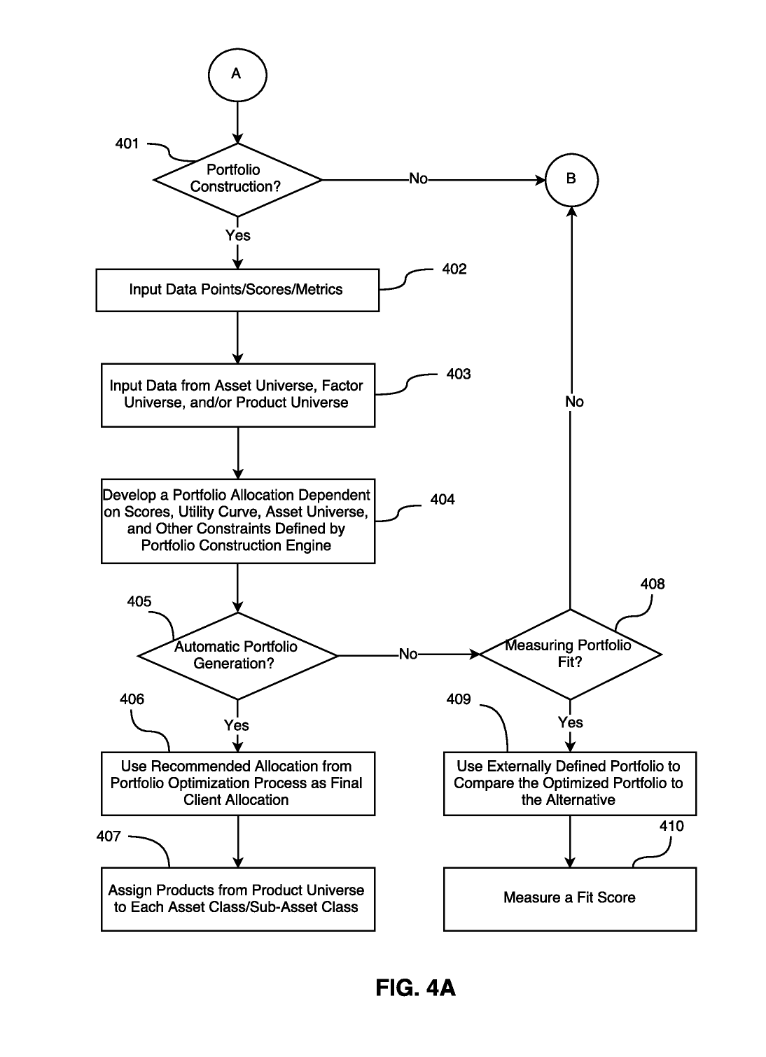

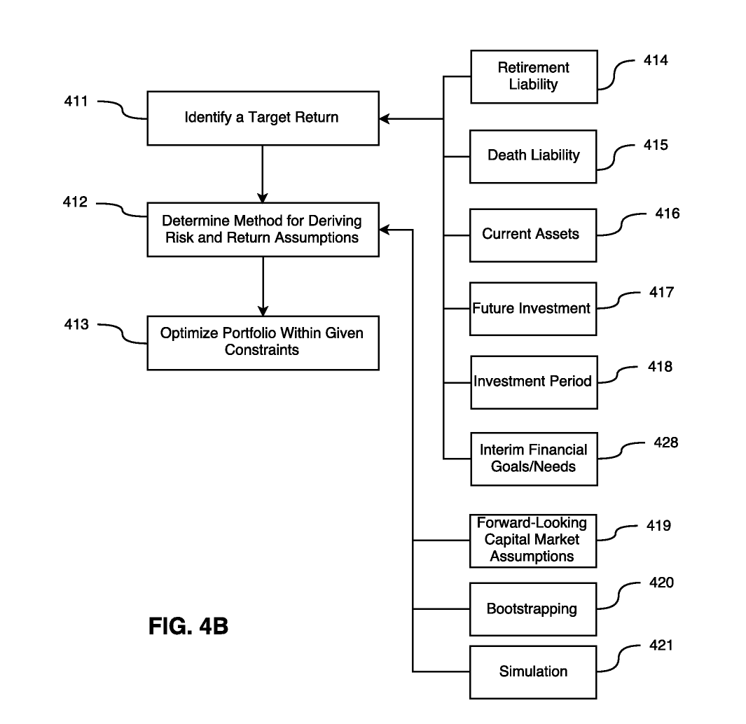

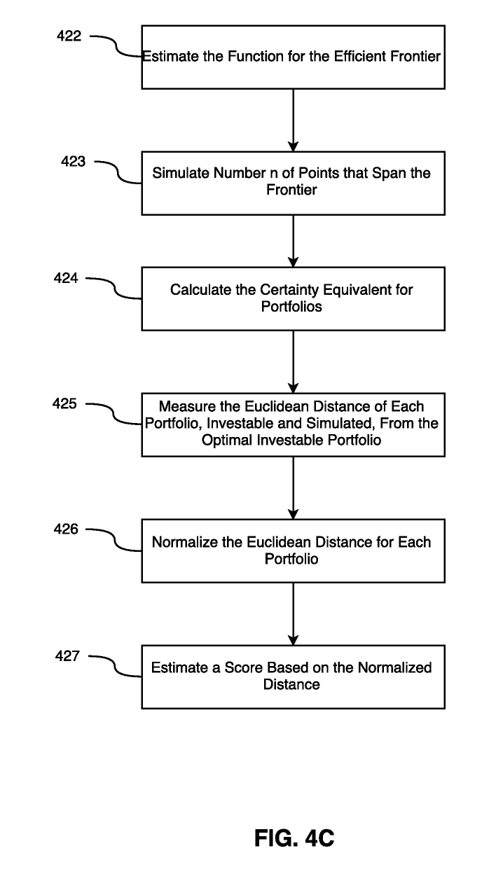

As indicated in block 308, the method includes determining an application for use. In one embodiment, the game scores or metrics 106 (FIG. 1) can be used for portfolio construction 401, as depicted in FIG. 4A. Specifically, the portfolio construction process comprises the steps of inputting a user's data points, scores, and/or metrics 402; and inputting appropriate data from asset universe 109 (FIG. 1), factor universe 108 (FIG. 1), and/or product universe 110 (FIG. 1) as indicated in block 403. In some embodiments, the portfolio construction process includes other constraints. Without limitation, other constraints include limits on asset class exposure, maximum allocation to single asset class, among others. Additionally, current assets within the asset universe 109 (FIG. 1) may comprise various types of assets such as ETFs, mutual funds, stocks, bonds, and the like.

As indicated in block 404, the application 118 (FIG. 1) uses the individual's economic fingerprint, or scores, to develop a portfolio allocation that is dependent on scores, utility curve, asset universe, factor universe, product universe, and any other constraints defined by the portfolio construction engine 119 (FIG. 1).

The portfolio construction process can be used to produce automatic portfolio generation as indicated in block 405, which uses recommended allocation from the portfolio optimization process as final client asset allocation 406 and assign products 126 (FIG. 1) from the product universe 110 (FIG. 1) to each asset class/sub-asset class 407.

An exemplary embodiment of the portfolio optimization process of the present method is illustrated in FIG. 4B. The optimization process includes determining, via, e.g., the portfolio construction engine 119 (FIG. 1), a target return 411 using values that represent retirement liability 414, death liability 415, interim financial goals/needs 428, current assets 416, future investment 417, and investment period 418, which accounts for the user's retirement age and current age. In operation, financial advisors can use either historical inputs or user-defined inputs, wherein historical inputs are based on longest available history for a particular investment option and user-defined inputs allow the inclusion of dynamic capital market assumptions.

Using this approach, the present invention accelerates the optimization process by anchoring it with the target rate of return. The logic underpinning this approach characterizes all returns in normal distribution that are less than zero or some target rate of return as losses while all returns that are greater than or equal to zero or some hurdle rate of return are gains. The expected loss given the distribution and the expected gain are calculated and used as inputs to determining the target return.

Once the target return is identified, the portfolio construction engine 119 (FIG. 1) determines risk and return assumptions 412. In the illustrated embodiment, there are three primary ways to derive estimates of return and risk for asset classes used in the portfolio optimization process: forward-looking capital market assumptions 419, which can be calculated via the application 118 or derived from third parties; bootstrapping 420, which comprises resampling historic returns to derive an estimate of expected return and risk; and simulation 421, which includes performing a simulation of the underlying asset class returns to determine expected risk and return. One or more of the foregoing techniques can be used, depending upon embodiment.

The estimates of risk and return are used to optimize a portfolio 413, which includes using nonlinear optimization techniques that are robust to problems that involve finding global minima/maxima for various smooth and non-smooth functional forms.

Additionally, portfolios can be mapped by maximizing the certainty equivalent for a given level of utility, conditional upon investor preferences. The process for deriving a score for mapping portfolio includes estimating the function for the efficient frontier 422 (FIG. 4C) using a nonlinear least squares optimization and then estimating the expected return for a range of volatilities. The process further includes simulating a number n of points that span the frontier 423 (FIG. 4C) and calculating the certainty equivalent (CE) for portfolios 424 (FIG. 4C) using the utility functions for decisions under risk and decisions under ambiguity and time preferences.

The process further includes measuring the Euclidean distance 425 (FIG. 4C) and normalizing each element of the resulting distance vector by the maximum distance 426 (FIG. 4C). It is contemplated, however, that the process can utilize other types of distance metrics. The normalized distance is then used to estimate a score 427 (FIG. 4C). In one embodiment, scores can be applied for portfolio scoring and for product scoring.

Alternatively, the portfolio optimization process can be used for measuring portfolio fit 408, which uses an externally defined portfolio, either as defined by a firm in standard “risk buckets” or as invested and managed by another advisor, to compare the optimized portfolio to the alternative 409 and measure a “fit score” 410.

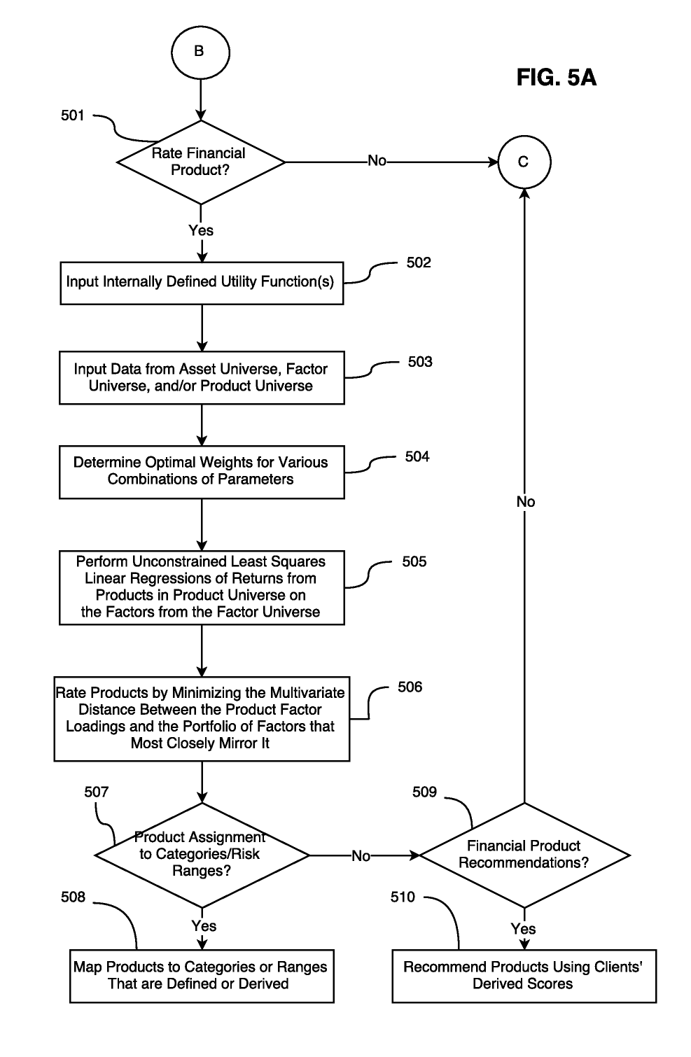

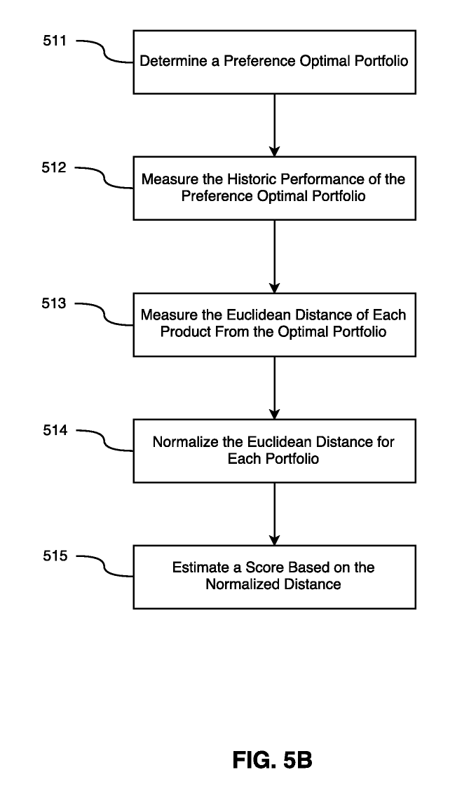

In another embodiment, internally defined utility functions and the asset universe can be used for product rating process, as indicated in block 501 in FIG. 5A. This process comprises the steps of inputting one or more internally defined utility functions 502 and the parameter ranges to use factors from the factor universe 503 to determine optimal weights for various combinations of parameters 504. As indicated in block 505, unconstrained least squares linear regression of returns is performed for products 126 (FIG. 1) in product universe 110 (FIG. 1) on the factors 128 (FIG. 1) from the factor universe 108 (FIG. 1). It is contemplated that Principal Component Analysis may be used to reduce the dimension of the analysis and to deal with a large number of assets, a situation that can lead to problems associated with the scale of data under consideration using other methods. The products 126 (FIG. 1) are rated by minimizing the multivariate distance between the product factor loadings derived from regression and the “portfolio” of factors that most closely mirrors it 506.

In some embodiments, the process for deriving a score includes determining a preference optimal portfolio 511 (FIG. 5B); measuring the historic performance of the preference optimal portfolio 512 (FIG. 5B); measuring the Euclidean distance of each product from the optimal portfolio 513 (FIG. 5B); normalizing the Euclidean distance for each portfolio 514 (FIG. 5B); and estimating a score based on the normalized distance 515 (FIG. 5B). Product rating 117 (FIG. 1) is stored in the product universe 110 (FIG. 1).

The financial product rating can be used to determine product assignment to categories/risk ranges 507, which uses minimized distance to map products to categories or ranges that are defined or derived based on utility curve and microeconomic interpretation of parameter ranges 508. Additionally, the financial product rating can be used to make financial product recommendations 509, which uses the individual's derived scores stored in database to create factor portfolio profile versus asset class universe profile. Products can be recommended based on how closely they align with the individual's risk profile as measured by distance 510.

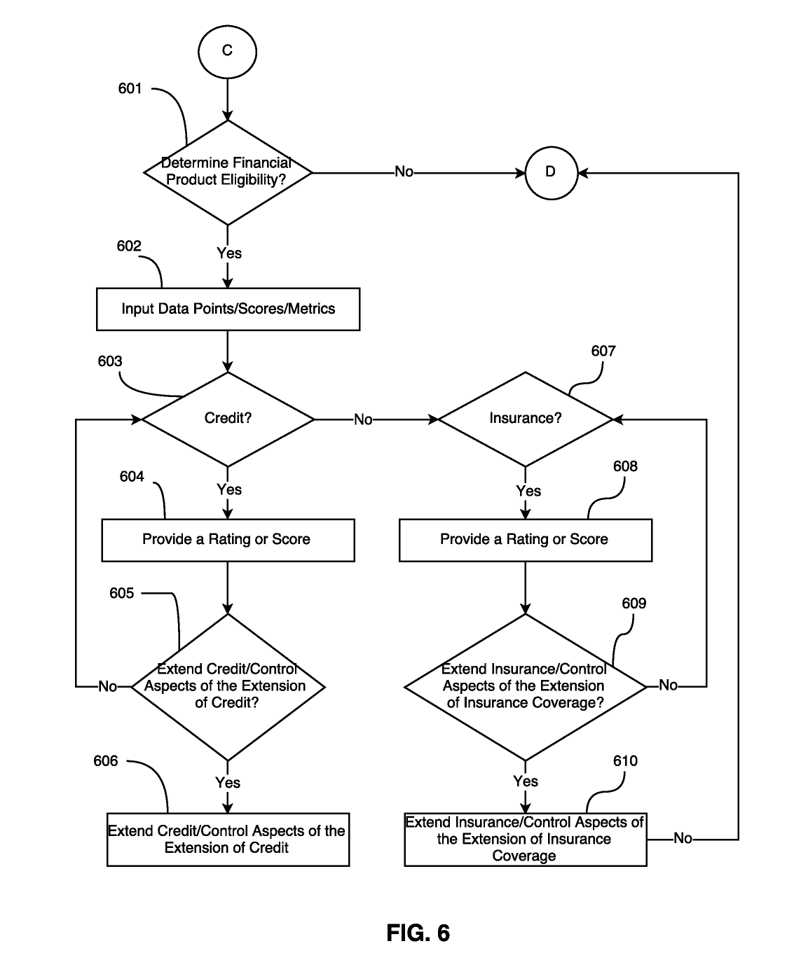

In yet another embodiment, the scores can be used for determining financial product eligibility 601, as depicted in FIG. 6. For credit scoring/rating, the individual's scores are used along with inputs from other sources 602. The sources may be internally or externally derived, developed, and/or acquired. In one embodiment, the rating or score can be used for providing credit 603. If used for providing credit, the application 118 (FIG. 1) provides a score or rating for each user 604, and determines whether or not to extend credit or to control aspects of the extension of credit, such as interest rate, available credit, and the like 605. If a user's score is above a threshold for eligibility, the application 118 (FIG. 1) recommends extending credit 606.

For providing insurance 607, the application 118 (FIG. 1) provides a rating or score for each user 608 to determine whether or not to extend insurance or to control aspects of the extension of insurance coverage, such as premium, deductible, riders/contract amendments, and the like 609. If a user's score is above a threshold for eligibility, the application 118 (FIG. 1) recommends extending insurance 610. The present invention is particularly advantageous in that it is forward-looking rather than backward looking, so as to provide individuals with a second chance to obtain credit or insurance.

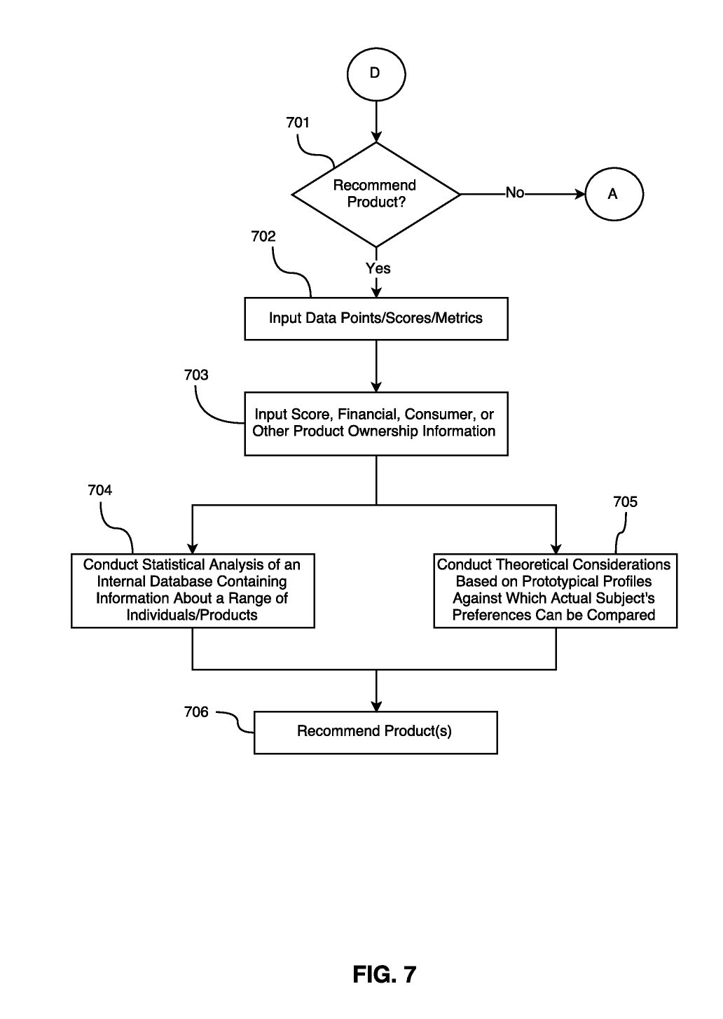

In a final exemplary embodiment, the present system can be used for making product recommendations 701, as depicted in FIG. 7. As illustrated in block 702, the product recommendations process includes inputting data points, scores, and/or metrics. Additionally, other constraints derived from internal database of information about scores and financial, consumer, or other product ownership are provided 703.

In one embodiment, products can be recommended via the application 118 (FIG. 1) based on statistical analysis of an internal database constraining information about a range of individuals, the products they own, and/or other information from the preference data 704. Alternatively, products can be recommended based on theoretical considerations based on prototypical profiles against which actual subjects' preferences can be compared.

In some embodiments, the application 118 (FIG. 1) can recommend a first set of products from step 704 and a second set of products from step 705 such that the first set of products meet the criterion of step 704 and the second set of products meet the criterion of step 702; and each of the products within the first set of products and the second set of products are different. In another embodiment, one or more of the first set of products can overlap with one or more of the second set of products such that some of the products of the first and second set of products meet the criterion of both steps 704 and 705. In yet another embodiment, the application 118 (FIG. 1) can recommend one set of products, wherein all of the recommended products meet the criterion of both steps 704 and 705.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A computer based method, comprising the steps of:
providing, by a computing device, an activity for measuring financial preferences, wherein said financial preferences comprise risk preferences, ambiguity preferences, time preferences, and distribution preferences;
receiving data, by said computing device corresponding to said financial preferences of at least one user, and data from a factor universe, an asset universe, and a product universe;
determining, by said computing device one or more parameters corresponding with said financial preferences of said at least one user; and
mapping with confidence intervals, by said computing device said one or more parameters into at least one user-specific score corresponding to said at least one user based on said financial preferences associated with said at least one user.

2. The method of claim 1, further comprising the steps of:
developing, by a portfolio construction engine, a portfolio allocation dependent on said at least one user-specific score, at least one utility curve, and constraints, wherein said constraints comprise assets in said asset universe.

3. The method of claim 2, further comprising the steps of:
automatically recommending allocation from portfolio optimization; and
assigning one or more products from said product universe to each of said assets.

4. The method of claim 2, further comprising the steps of measuring portfolio fit.

5. The method of claim 1, further comprising the steps of outputting a recommendation for a financial product based on said at least one user-specific score.

6. The method of claim 1, further comprising the steps of:
determining whether said at least one user-specific score qualifies for a credit extension; and
if said at least one user-specific score qualifies for said credit extension, extending credit to said at least one user associated with said at least one user-specific score.

7. The method of claim 1, further comprising the steps of:
determining whether said at least one user-specific score qualifies for an insurance policy; and
if said at least one user-specific score qualifies for said insurance policy, extending insurance to said at least one user associated with said at least one user-specific score.

8. The method of claim 1, further comprising the steps of:
identifying a target return for said at least one user;
determining risk and return assumptions; and
optimizing a portfolio corresponding with said at least one user.

9. The method of claim 1, further comprising the steps of measuring a fit score for a financial product based on said at least one user-specific score.

10. The method of claim 1, further comprising the steps of rating a financial product based on said at least one user-specific score, at least one utility curve, and constraints, wherein said constraints comprise assets in said asset universe.

11. A computer based method, comprising the steps of:
providing, by a computing device, an activity for measuring financial preferences, wherein said financial preferences comprise risk preferences, ambiguity preferences, time preferences, and distribution preferences, wherein said activity comprises a graph having a randomly generated budget line, further wherein said graph comprises axes that are scaled to represent economic choices based on said financial preferences being measured, further wherein said activity comprises individual decision problems;
completing said individual decision problems by allowing at least one user to move a point on said graph to a desired location on said graph using said computing device, wherein said desired location represents said financial preferences of said at least one user;
determining, by said computing device one or more parameters corresponding with said financial preferences of said at least one user; and
mapping with confidence intervals, by said computing device said one or more parameters into at least one user-specific score corresponding to said at least one user based on said financial preferences associated with said at least one user.

12. The method of claim 11, further comprising the steps of:
developing, by a portfolio construction engine, a portfolio allocation dependent on said at least one user-specific score, at least one utility curve, and constraints, wherein said constraints comprise assets in said asset universe.

13. The method of claim 11, further comprising the steps of:
automatically recommending allocation from portfolio optimization; and
assigning one or more products from said product universe to each of said assets, wherein said one or more products meet at least one predefined criterion.

14. The method of claim 11, further comprising the steps of measuring a fit score for a financial product based on said at least one user-specific score.

15. The method of claim 11, further comprising the steps of rating a financial product based on said at least one user-specific score, at least one utility curve, and constraints, wherein said constraints comprise assets in said asset universe.

16. A system, comprising:
a memory having stored thereon instructions;
a processor to execute said instructions resulting in an application;
said application configured to:
provide an activity for measuring financial preferences, wherein said financial preferences comprise risk preferences, ambiguity preferences, time preferences, and distribution preferences;
receive data corresponding to said financial preferences of at least one user;
determine one or more parameters corresponding with said financial preferences of said at least one user; and
map said one or more parameters into at least one user-specific score corresponding to said at least one user based on said financial preferences associated with said at least one user.

17. The system of claim 16, wherein said activity comprises a virtual reality interface.

18. The system of claim 16, wherein said activity comprises a graph having a randomly generated budget line, further wherein said graph comprises axes that are scaled to represent economic choices based on said financial preferences being measured.

19. The system of claim 16, wherein said activity is configured to allow users to solve individual decision problems by moving a point on said graph to a desired location on said graph, further wherein said desired location represents said financial preferences of said at least one user.
